(19) United States
(12) Patent Application Publication
(10) Pub. No.: US 2013/0173354 A1
(43) Pub. Date: Jul. 4, 2013

(54) ISSUE-BASED ANALYSIS AND VISUALIZATION OF POLITICAL ACTORS AND ENTITIES

(71) Applicants: LISA STRAUSFELD, Portland, OR (US); HILLA KATKI, Brooklyn, NY (US); ADAM SUHARJA, New York, NY (US); LAURA STRAUSFELD, New York, NY (US)

(72) Inventors: LISA STRAUSFELD, Portland, OR (US); HILLA KATKI, Brooklyn, NY (US); ADAM SUHARJA, New York, NY (US); LAURA STRAUSFELD, New York, NY (US)

(21) Appl. No.: 13/663,331

(22) Filed: Oct. 29, 2012

Related U.S. Application Data
(60) Provisional application No. 61/553,118, filed on Oct. 28, 2011.

(51) Int. Cl. G06Q 10/06; G06Q 50/26

(52) U.S. Cl. CPC G06Q 10/06393; G06Q 50/26
USPC 705/7.39

(57) ABSTRACT

A data processing system provides an issue-based analysis and graphical visualizations of the political orientation of members of Congress individually (e.g. political actors), as collective political entities, such as the Congress as a whole, and the individual branches of Congress, the Senate and the House of Representatives.

### CROSS REFERENCE TO RELATED APPLICATIONS

This application claims the benefit of U.S. Provisional Application No. 61/553,118, filed on Oct. 28, 2011, which is incorporated by reference herein in its entirety.

### BACKGROUND

1. Field of Disclosure

The disclosure generally relates to the field of data analysis of political entities, in particular to providing an issue-based analysis and graphical visualizations of the entities' political orientation on various issues.

2. Description of the Related Art

Considerable attention is focused everyday on the political landscape. The actions and attitudes of members of Congress are scrutinized and evaluated by news organizations, lobbyists, interests, and others. The actions of Congress have impacts across the entire range of political issues. For any given political issue, numerous interest groups exist, each can be characterized as either liberal, conservative, or non-partisan in political orientation. These interest groups often lobby members of Congress, as well as grade members of Congress on the issues of interest to them in regards to that group's political orientation. Thus, a conservative interest group tends to grade conservative members of Congress favorably where they oppose higher taxes, gun control, abortion rights, etc., while a liberal interest group would grade such a member of Congress negatively.

The sheer volume of information about Congress and its activities, the huge variety of issues and political events of interest makes it very difficult to understand the overall political orientation of Congress (and its branches the House and Senate) as collective political entities. While interest groups can provide judgments about individual members of Congress, no current interest group provides an overall assessment of the political orientation of Congress (or its branches) on individual issues, categories of issues. Further, while Congress is operating on a daily basis, there are no means available to assess the political orientation of Congress on a daily basis, let alone a real time or near real-time basis with respect to the scores provided by the interest groups.

### SUMMARY

A data processing system provides an issue-based analysis and graphical visualizations of the political orientation of members of Congress individually (e.g. political actors), as collective political entities, such as the Congress as a whole, and the individual branches of Congress, the Senate and the House of Representatives.

The data processing system, referred to herein as the Major League Politics (MLP) system, uses information provided by various interest groups that grade or ‘score’ individual members of Congress with respect to various political issues. Interest groups provide this information, sometimes called a “scorecard,” generally in response to or anticipation of political events such as the introduction of a new bill or the passage of the bill into law, as well as on a periodic basis, such as monthly, or quarterly, or in anticipation of Congressional elections. The MLP system provides web-based interfaces and data listeners that allow interest groups to programmatically provide their scores to the MLP system as they are released. Since the interest groups tend to follow political activities very closely and issue scores frequently, this feature provides the system with real time or near real time access to the scores. The MLP system accumulates and aggregates the interest group scores and determines for each member of Congress an index score with respect to each issue in various political categories—social, economic, domestic, and international—each of which encompasses multiple issues.

The index score represents the political orientation of a member of Congress or branch/body of Congress with respect to a political issue or political event. Since the individual scores come from interest groups that use different score systems and have differing political orientations—some interest groups are liberal, some are conservative, and some are non-partisan—the MLP system is configured to normalize the scores from the different groups into a common scoring framework so that they can be meaningfully combined, thereby providing a consolidated index score that reflects the overall political orientation of the member of Congress on each political issue and in each political category. The common scoring framework further allows comparison of the individual members of Congress to each other with respect to any particular issue or category.

The MLP system maintains the scoring information in database and provides a variety of graphical visualizations of the issues and members' scores, using a graphical query builder. In one embodiment, a horizontal, double ended, bar chart format is used, in which the political issues are arrayed from top to bottom. The horizontal center of the bar chart represents an index score of 0. For each issue a bar is shown scaled in size based on the magnitude of the member's index score for the issue, and extended either left or right from the center, depending on the political orientation (liberal to the left, conservative to the right) of the member, as determined based on the scores from the interest groups. The bars can be sorted (vertical ordering) based on the index scores, categories, voting behavior, or other criteria. This data driven visualization can reveal that a nominally conservative member of Congress is in fact more liberal on certain political issues than would be assumed merely by their party affiliation. The MLP system graphical query builder can be used to select and show the political direction with respect to members of Congress, and various attributes or metrics, such as bills introduced or pass, financial contributions, or the like.

Further the MLP system can aggregate the index scores of the underlying members at the entity level of a branch (House or Senate) or the entire Congress. Again, a graphical query builder is used to select the branch, date period, sort order, and aggregate measure (e.g., number of votes, number of bills) with respect to each issue, and this information is shown in a similar structured horizontal, double ended bar chart. Another visualization is a trend line that shows the change or movement in the index score over time with respect to an individual political issue or category, for either a member of Congress, branch or Congress as whole.

Other visualizations are possible as well. For example, a ‘voyeur’ is used to query and show members of Congress based on their profile attributes, financial contributions, votes, demographic factors, or the like.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF DRAWINGS

The patent or application file contains at least one drawing executed in color. Copies of this patent or patent application publication with color drawings will be provided by the U.S. Patent and Trademark Office upon request and payment of the necessary fee.

FIG. 1 is a block diagram illustrating a data processing system for providing an issue-based analysis and graphical visualizations of political entities' political orientation on various issues.

FIG. 2A is a block diagram illustrating a Congress database, and FIG. 2B is a block diagram illustrating the political office data structure.

FIG. 3 is a block diagram illustrating a political event database.

FIG. 4A is a graphical user interface illustrating a news headline received from a feed source.

FIG. 4B is a graphical user interface illustrating a tweet describing a link to a created visualization.

FIG. 4C is a graphical user interface illustrating a visualization displaying pertinent details about members of a chamber who voted on a bill as requested in a query.

FIG. 4D is a graphical user interface illustrating a visualization displaying comments made by a member during the progression of a bill.

FIG. 4E is a graphical user interface illustrating a second example of a visualization displaying information for members of a chamber based on the received query.

FIG. 4F is a graphical user interface illustrating a third example of a visualization displaying information about members of a chamber based on the received query.

FIG. 4G is a graphical user interface illustrating a visualization displaying information about a member's voting record for a particular session based on the received query.

FIG. 4H is a graphical user interface illustrating a second example of a visualization displaying information about a member's voting record for a particular session based on the received query.

FIG. 4I is a graphical user interface illustrating a third example of a visualization displaying information about a member's voting record for a particular session based on the received query.

FIG. 4J is a graphical user interface illustrating a visualization displaying information about a Congress' voting record based on the received query.

FIG. 4K is a graphical user interface illustrating a visualization displaying a daily tracker chart indicating potential effects of current political events on the Congress' orientation.

FIG. 4L is a graphical user interface illustrating a visualization displaying a query window used to build a query for requesting a chart.

FIG. 4M is a graphical user interface illustrating a visualization including a trend line chart displaying a trend line indicating a change in a chamber's orientation on a particular issue over a period of time.

FIG. 4N is a graphical user interface illustrating a visualization including a chart with bars for sub-categories indicating the number of bills introduced in a chamber.

FIG. 4O is a graphical user interface illustrating a visualization of FIG. 4N with an additional layer of information displayed in response to selection of a bar.

FIG. 4P is a graphical user interface illustrating a visualization including a chart displaying sub-categories and their interest groups that provide scores for political events associated the sub-categories.

FIG. 4Q is a graphical user interface illustrating a scorecard generated by the data processing system indicating the senators' voting scores for year 2010 on political events associated with labor issue sub-category as determined by the AFL-CIO interest group.

### DETAILED DESCRIPTION

The data processing system described herein provides an issue-based analysis and graphical visualizations of political entities' political orientation on various issues. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

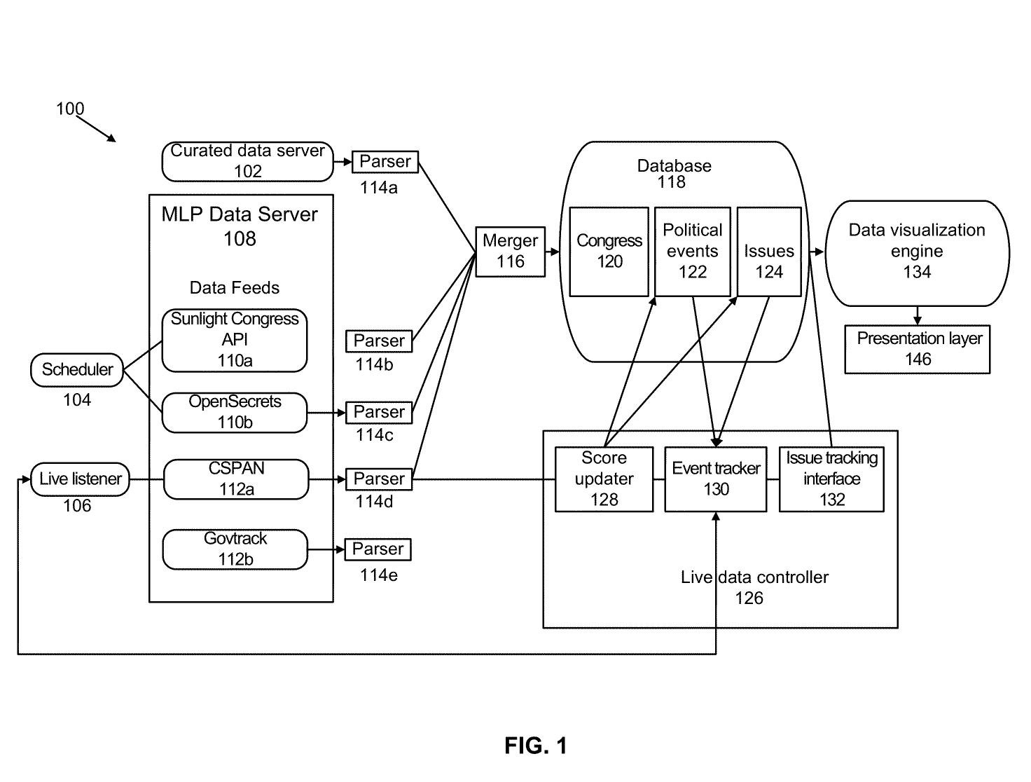

Referring to FIG. 1, the MLP system 100 for providing an issue-based analysis and graphical visualizations of political entities' political orientation on various issues comprises a scheduler 104, a live listener 106, a curated data server 102, a data server 108, parsers 114a-g, a merger 116, a database 118, a live data controller 126, a data visualization engine 134 and a presentation layer 146. The system 100 may be implemented using a single computer, or a network of computers, including cloud-based computer implementations. The computers are preferably server class computers including one or more high-performance CPUs and 1 G or more of main memory, as well as 500 Gb to 2 Tb of computer readable, persistent storage, and running an operating system such as LINUX or variants thereof. The operations of the MLP system 100 as described herein can be controlled through either hardware or through computer programs installed in computer storage and executed by the processors of such servers to perform the functions described herein. The service 100 includes other hardware elements necessary for the operations described here, including network interfaces and protocols, input devices for data entry, and output devices for display, printing, or other presentations of data. As will become apparent, the various data processing operations described herein are sufficiently complex and time consuming as to require the operation of a computer system such as the MLP system 100, and cannot be performed solely in the human mind by mental steps.

The scheduler 104 is a computing device with at least a processor and a memory, and which is configured to periodically check for updates from various data feeds and to provide the updates to data server 108, and is one means for performing this function. These data feeds are used by various interest groups, experts, or other data sources to provide a grade or a score for individual members of Congress with respect to various political issues. The data feeds are received over a communications network, such as the Internet.

To determine scores for political issues for various members of Congress, the interest groups or experts provide scores for various political events (like progression of a bill through a chamber). Each interest group determines for itself how important a political event. The determined importance can be positive or negative, so a bill can be very important if the wide ranging impact is very negative or very positive, with respect to the underlying political orientation of the sponsor. Progression of a bill also impacts magnitude, as legislation that has progressed further towards becoming law will become more important. Based on the determined importance and progression of political events, the interest groups determine scores for the political events for various members. The interest groups provide these scores through data feeds, called a “scorecard”, typically in response to or anticipation of certain political events such as the introduction of a new bill or the passage of the bill into law, as well as on a periodic basis, such as monthly, or quarterly, or in anticipation of Congressional elections.

Additionally, the data feeds provide information like how a particular member of Congress has voted on a particular bill, groups providing political contributions to the member, the amount of contribution provided by the groups to the member, member's financial assets (like details about a stock portfolio, location and price of real estate). The scheduler 104 receives this information and provides it to the data server 108.

The live listener 106 is a computing device with at least a processor and a memory, and that is configured to receive data from live sources or data sources that are frequently updated (e.g. sources updated more than once a day) and provide the received data to the data server 108, and is one means for performing this function. Examples of live or frequently updated sources include GovTrack and CSPAN. The live listener 106 is communicatively coupled to a political event tracker 130 in live data controller 126. The live listener 106 retrieves a list of flagged events from political event tracker 130 and monitors data sources for information about the flagged events. The live listener 106 retrieves similar information from these monitored sources as information retrieved by the scheduler 104 from its sources. The live listener 106 transmits the retrieved information to the data server 108.

The data server 108 is a computing device with at least a processor and a memory, and which is configured to includes various interfaces (e.g., application programming interfaces) for receiving or retrieving information from the scheduler 104 and live listener 106, and is one means for performing this function. Examples of interfaces includes sunlight Congress interface 110a for retrieving information from Sunlight, opensecret interface 110b for retrieving information from OpenSecrets, cspan interface 112a for retrieving information from CSPAN and Govtrack interface 112b for retrieving information from Govtrack. Sunlight, OpenSecrets, CSPAN, and Govtrack are organizations that provide online data feeds; the corresponding application programming interfaces are configured to receive these data feeds according to feed specifications provided by the organizations.

The curated data server 102 is a computing device with at least a processor and a memory, and which is configured to receive manually edited data sets (e.g., databases, spreadsheets) for specific types of data that are not provided by the data feeds, and is one means for performing this functions. In one embodiment, rows in the received data set have an associated unique key for a corresponding entry in database 118, such as a Congress member.

The parsers 114a-e are computing devices with at least a processor and a memory, and which are configured to receive data from their data sources (e.g., interfaces 110a,b, 112a,b), parse or format the data received data in a desired format and transmit the parsed data to merger 116, and are one means for performing this function. In one embodiment, curated data 102 and interfaces 110a-b, 112a-b each have an associated parser 114a-e that parses data received from these sources.

The merger 116 is a computing device with at least a processor and a memory, which is configured to receive the parsed data from the parsers 114a-e and combine the parsed data into organized records with respect to individual members of Congress, and is one means for performing this function. Different data sources may provide data for different fields corresponding to a Congress member's record. The merger 116 combines data for different fields and transmits the combined data to the database 116.

Additionally, the merger 116 is configured to normalize the scores received from the interest groups, experts or other sources into index scores in a common scoring framework. In one embodiment, the merger 116 normalizes the normalized index scores are from −100 to 100, wherein the positive scores represent a conservative orientation and negative scores represent a liberal orientation. In one embodiment, the merger also determines a base color and a color score corresponding to the normalized index score. The base color and the color score are used in visualizations to indicate varying degrees of a political entity's liberal or conservative orientation. An example formula for determining the base color is:

N=C−IG

wherein C is a constant (like 50) and IG score is a score provided by an interest group. If the interest group is a conservative group, and N is a positive number (i.e., IG Score<C) then the base color is Blue (representing a liberal orientation), otherwise if N is a negative number (i.e., IG Score>C), then the base score color is Red (representing a conservative orientation). If the interest group is a liberal group, and N is a positive number (i.e., IG Score<C), then the base score color is Red, otherwise if N is a negative number (i.e., IG Score>C), then the base score color is Blue.

An example formula for calculating the color score is:

|N|*2

wherein the color score is the percentage of black added to a base color to indicate the varying degree of orientation. For example, the AFL-CIO (a Blue group) gives a Congressperson a 72 for a labor issue. Using the formula indicated above, assuming C=50

N=50−72=−22.

Because N is a negative number, the base color is Blue. The color score=|−22|*2=44. Accordingly, the visualization would represent the Congressperson's orientation for the labor issue with color blue combined with 44% black.

The merger 116 transmits the combined data, including the index scores, base colors and color score for various issues, to the database 118. The merger 116 also prioritizes data by feed sources to handle conflicts such as redundancies.

The database 118 is a computing device with at least a processor and a memory, and which is configured to store the information about members of Congress, political events and various issues related to the members and political events. The database 118 comprises a Congress database 120, a political events database 122 and an issues database 124.

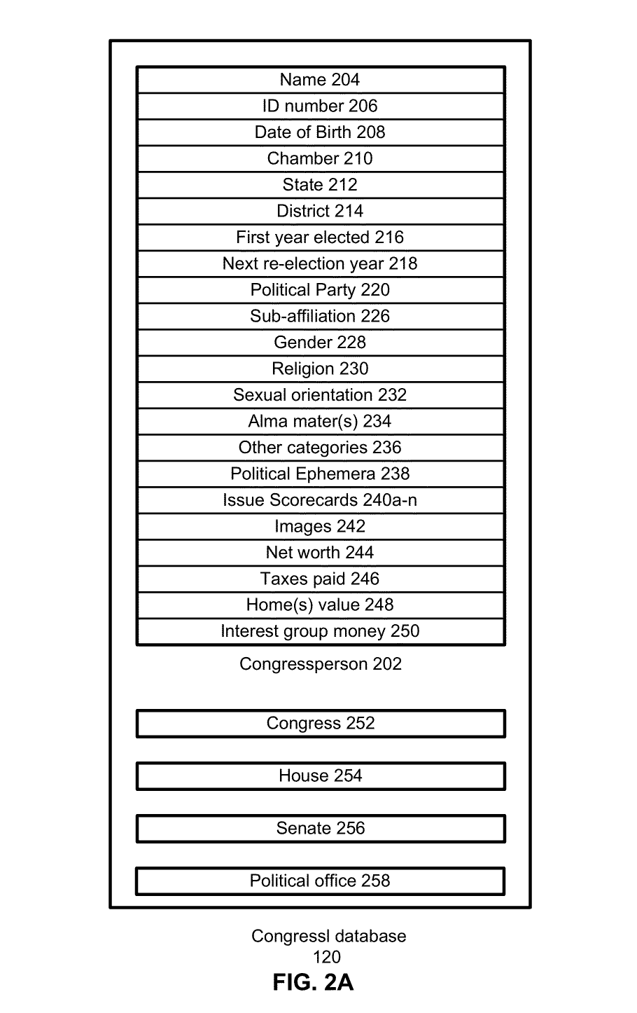

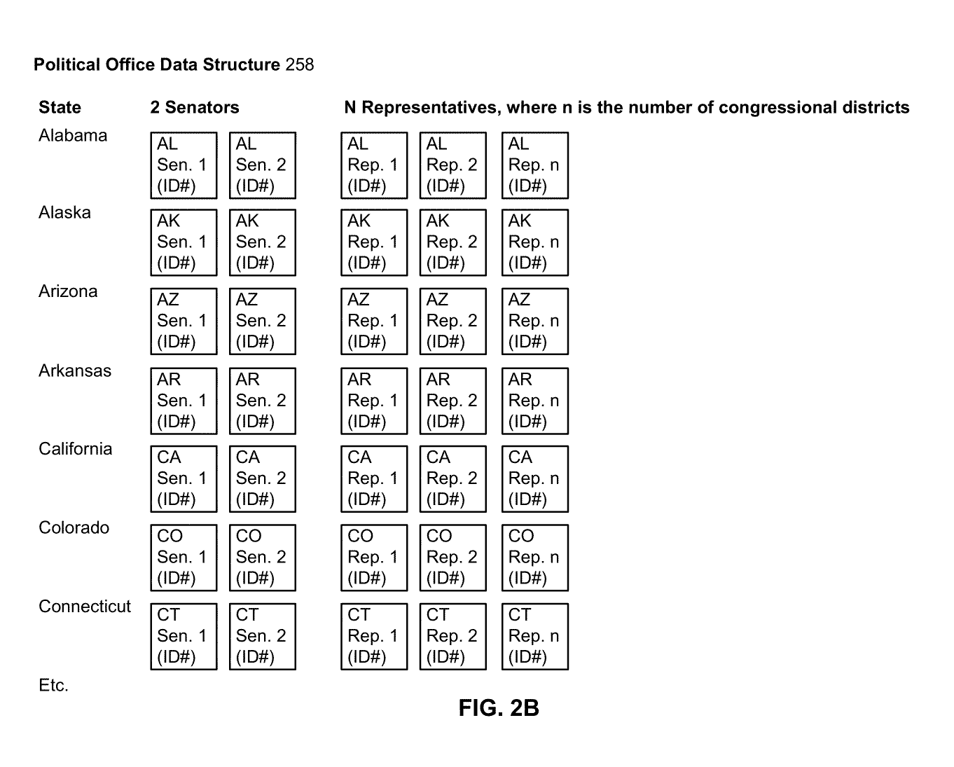

The Congress database 120 stores information about the members of Congress. FIG. 2A illustrates the Congress database 120. The Congress database 120 receives this information from sources like open Congressional databases and stores data structures like a member data structure 202, a Congress data structure 252, a house data structure 254, a senate data structure 256 and a political office data structure 258. In an embodiment where the database 120 is a relational database, the data structures are implemented as relational tables.

The member data structure 202 stores information for a member of Congress like the member's name 204, an identifier 206 that uniquely identifies the member, member's date of birth 208, chamber 210 the member belongs to, state 212 the member represents, district 214 the member represents, the first year 216 the member was elected, re-election year 218 indicating the year the member is up for re-election, member's political party 220, sub-affiliation 228 indicating a faction associated with the party that the member belongs to (e.g., Tea Party, Blue Dog Democrats), member's gender 228, member's religion 230, member's sexual orientation 232, member's alma maters 234, other categories 236 that member belongs to (e.g., novelists, posed nude, remarried more than once), member's political ephemera 238 indicating interesting biographic details about the member, member's issue scorecards 240a-n indicating index scores for the member on various issues (received from merger 116), member's image 242 or a set of images 242 (e.g., member's headshots, mug shots, celebrity look-alikes, baseball cards, home photo, shoe photo, vehicle photo, significant other's photo), member's net worth 244, taxes paid 246 by the member, member's home value 248 indicating value of the member's home(s), and member's interest group money 250 indicating annual contributions provided to the member by interest groups representing sectors like finance, business, lawyers, health, communications/electronics, energy, construction, labor, agribusiness, transportation, defense, human rights, environment, foreign policy, gun rights, abortion and women's issues.

The Congress data structure 252 stores scorecards for the current Congress and its predecessors (Congress of previous years) on various issues. These scorecards are based on the scorecards of individual members of Congress and are updated repeatedly as scorecards of members of Congress get updated.

The house data structure 254 stores scorecards for the current House of Representatives and its predecessors (House of Representatives of previous years) on various issues. These scorecards are based on scorecards of individual Congress members that belong to the House of Representatives and are updated repeatedly as scorecards of individual members get updated.

The senate data structure 256 stores scorecards for the current Senate and its predecessors (Senates of previous years) on various issues. These scorecards are based on scorecards of individual Congress members that belong to the Senate and are updated repeatedly as scorecards of individual members get updated.

Referring to FIG. 2B, the political office data structure 258 includes information about the members of Congress (the senators and the representatives) belonging to a state. The political office data structure 258 therefore includes identification of two senators and all of the representatives of each state. In one embodiment, the political data structure 258 is linked to the member data structure 202 and can be used to retrieve information stored in the member data structure 202 for a senator or a representative of a state. The member identifier 206 can be used as primary key to link the various data structures.

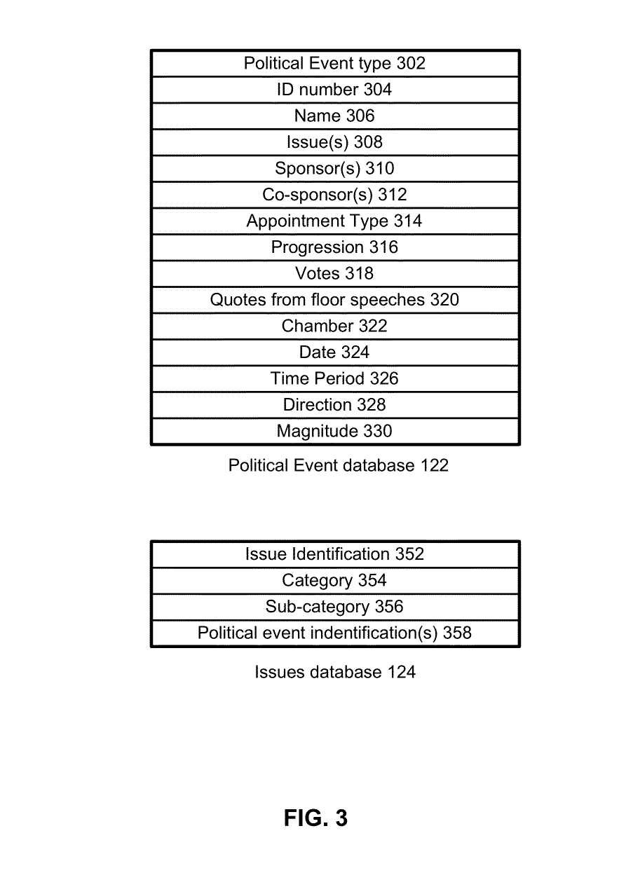

Referring to FIG. 3, the political event database 122 stores information about progression of a political event like a legislation (e.g., a bill or an amendment), a Congressional procedure (e.g., filibuster, motion to invoke cloture, motion to proceed/recommit)) and appointments (e.g., appointment of an ambassador, cabinet member, federal agency head, judicial officer like a federal judge or a Supreme Court justice).

In one embodiment, the political event database 122 stores for a political event a political event type 302 indicating the type of event (e.g., legislation, Congressional procedure, appointment), identification number 304 that uniquely identifies the event, name 306 of the political event, issue(s) 308 addressed by the political event (e.g., women's right, taxation etc.), sponsor(s) 310 of the event, co-sponsor(s) 312 of the event, appointment type 314 indicating the type of appointment (e.g., ambassador, cabinet member etc.) if the event type 302 is an appointment, progression 316 indicating a stage of progression of the event (e.g., for a bill, the stage may be introduction in a chamber (e.g. house), being analyzed by a committee in the chamber, on the floor in the chamber, voted in the chamber, passed by the chamber, in committee in the next chamber (e.g. senate), on the floor in the next chamber, voted in the next chamber, passed by the next chamber, vetoed or signed into law by the president), votes 318 indicating each member in either of the chambers who voted on the event and their vote, quotes 320 from floor speeches during the passage of the event, chamber 322 where the bill was introduced, date 324 when the event was introduced, time period 326 indicating the amount of time for which the event occurred in a chamber (e.g., filibuster lasted 30 hours in senate), direction 328 indicating the political party or an affiliation supporting the event (determined by political party or affiliation of the members supporting the event) and magnitude 330 of the event (determined by number of votes, sponsors, or co-sponsors in support of the event or the time period of the event (e.g., in case of filibuster).

Also shown in FIG. 3 is the issues database 124. The issues database 124 stores a list of issues and political events associated with each issue. The issues database 124 includes for an issue an identification 352 that uniquely identifies the issue, a category 354 associated with the issue (e.g., international, domestic, economic, social, domestic-economic, domestic-political, domestic-social & cultural, domestic-welfare), a subcategory 356 within a category indicated in category 354 (e.g., for international category, sub-categories include defense & military, foreign policy, immigration, homeland security and trade; for domestic category, sub-categories include agriculture & food, arts, crime, drugs, education, energy, environment, general government, housing, labor, law & judiciary, science & technology, transportation and veterans affairs; for economic category, sub-categories include budget, business, campaigns & elections, economy, financial services, social services and taxes; for social category, sub-categories include abortion, animal welfare, civil liberties & civil rights, children & families, guns, health care, LGBT issues, Medicaid & Medicare, religion and welfare & poverty; for domestic-economic category, sub-categories include agriculture, corporate governance, food & drugs, health care industry, environment, financial services, infrastructure, labor relations & employment, manufacturing, macroeconomic, science & technology; for domestic-political category, sub-categories include budget, campaign & elections, legislative process, civil liberties & civil rights, law reform and judiciary; for domestic-social & cultural category, sub-categories include abortion, animal welfare, arts, crime, guns, LGBT issues and religion; and for domestic-welfare category, sub-categories include children & families, education, health care, housing, social security, unemployment compensation and welfare & poverty) and political event identification(s) 358 indicating the political events associated with the issue. The political event identification(s) 358 is linked with identification number 304 in the political event database 122. This linkage allows identification of political events (and all their associated information like direction and magnitude for an event) stored in the political event database 122 for an issue identified by the issue identification number 352 stored in the issues database 124.

The live data controller 126 is a computing device with at least a processor and a memory, and which is configured to determine political events that may affect the index score of a political entity on a certain issue and store the list determined list of political events. The stored list of political events is monitored and used to update index scores. The live data controller 126 comprises a score updater 128, an event tracker 130 and an issue tracking interface 132. The issue tracking interface 132 is an interface (e.g., a set of web-based tools) that allows interest groups or experts to flag the relevant political events by issue. The event tracker 130 stores a list of flagged political events and transmits the list to live listener 106. The live listener 106 monitors data sources for information on the received list of political events. The score updater 128 receives information from live listener 106 and updates the index scores of political entities based on the received information.

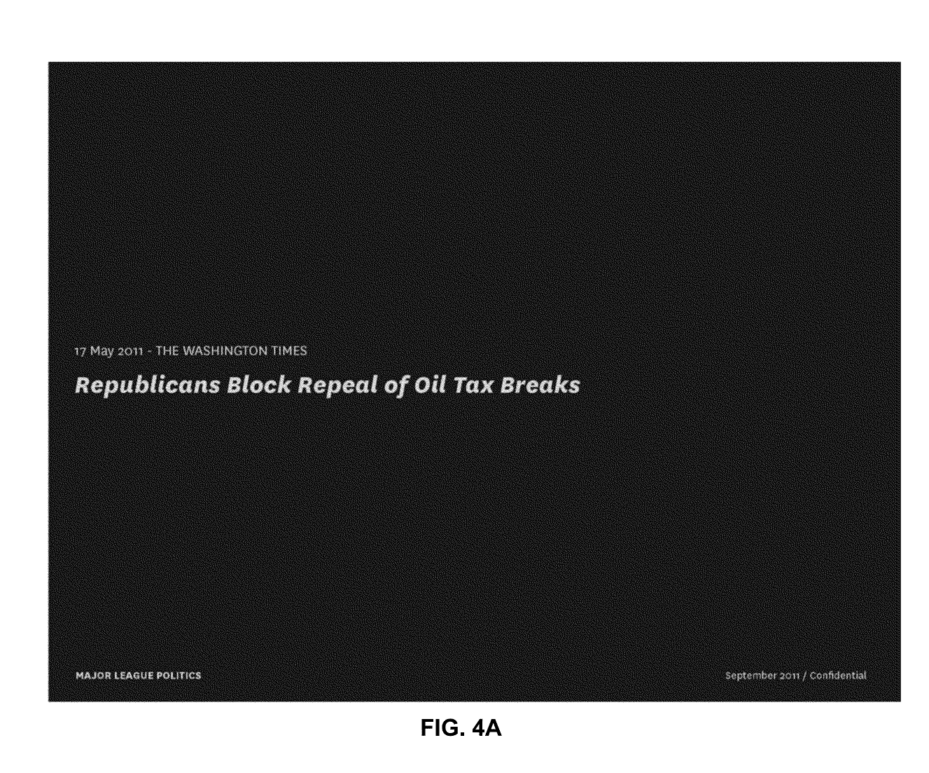

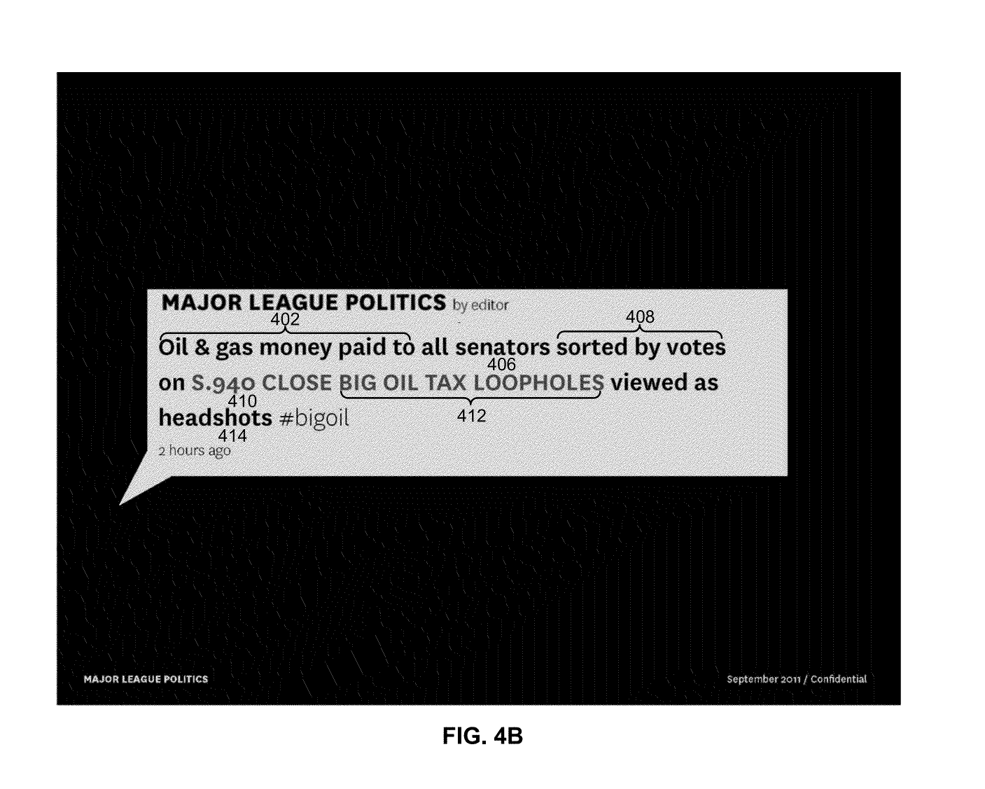

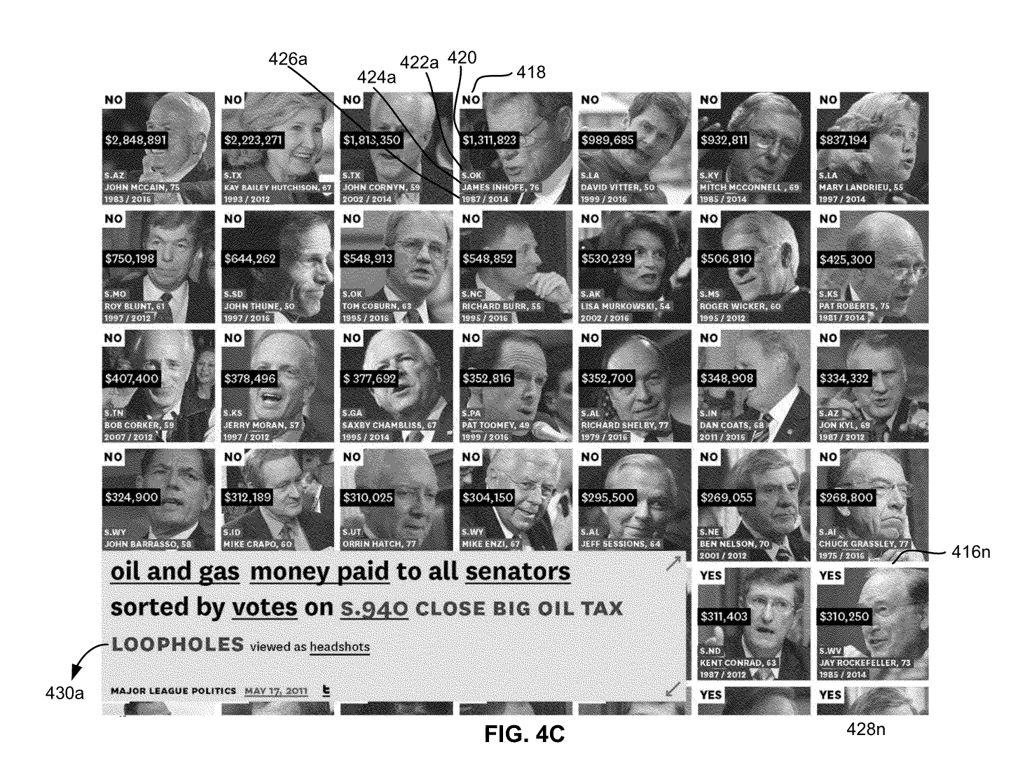

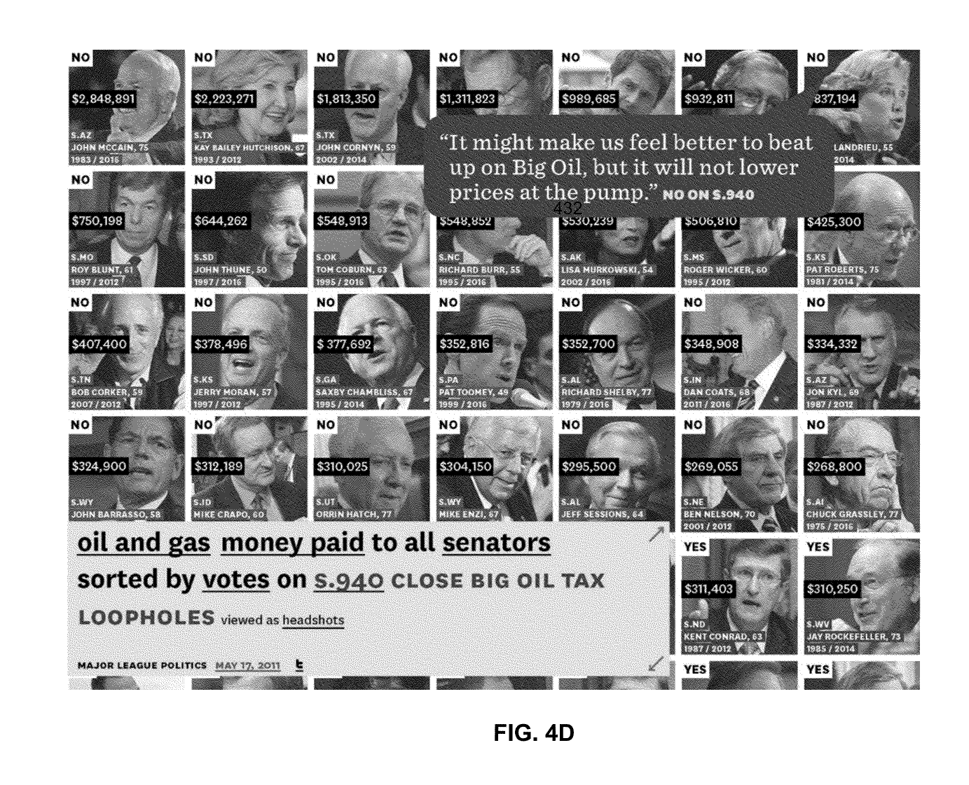

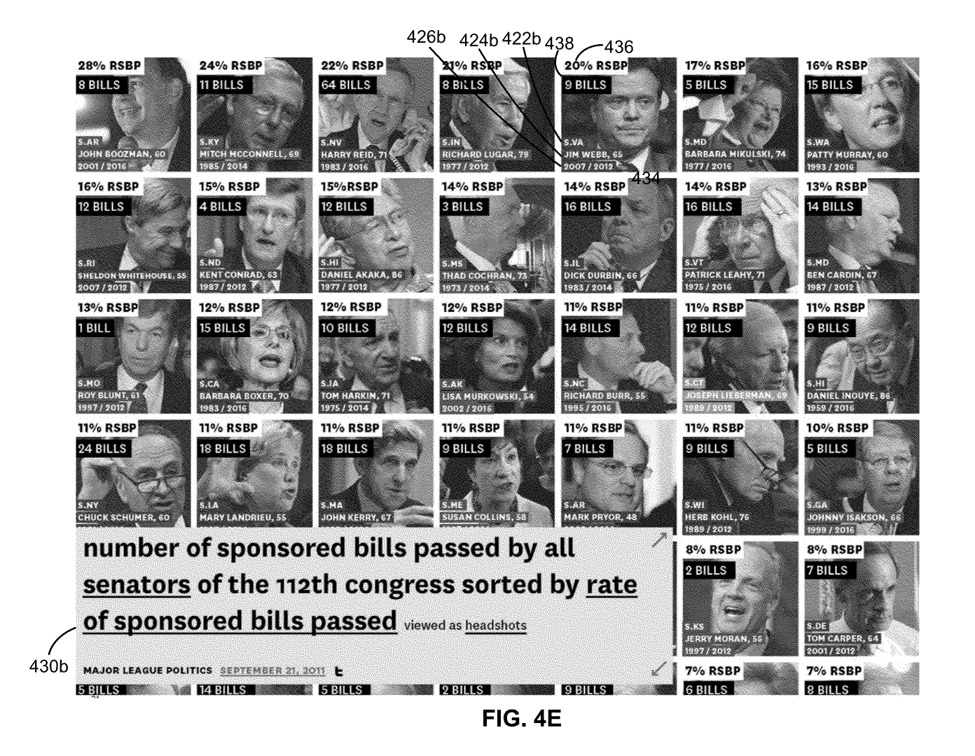

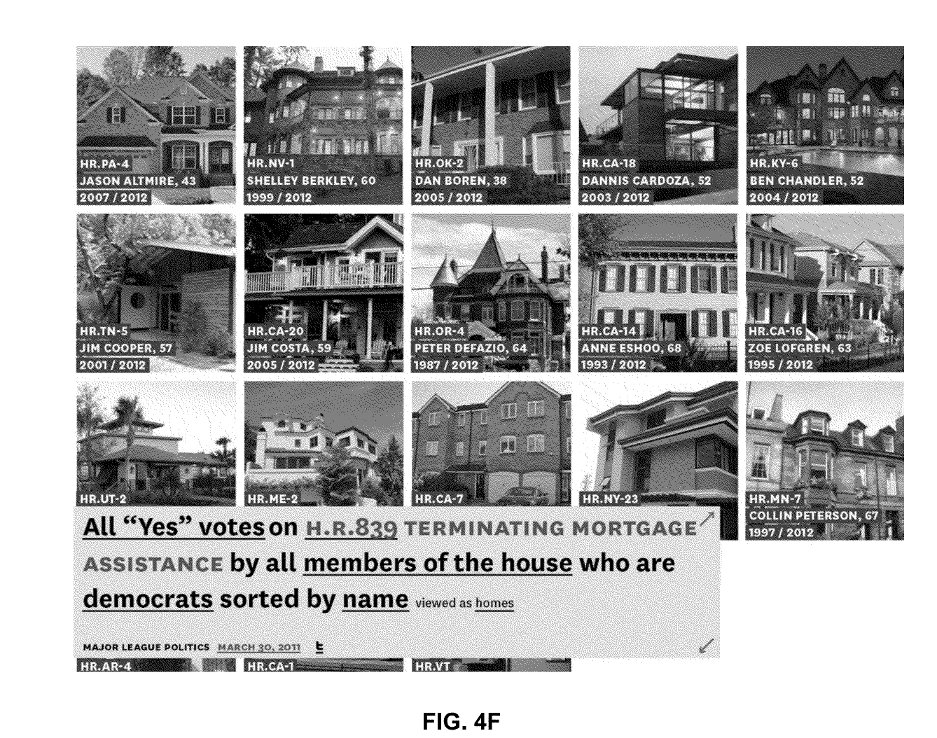

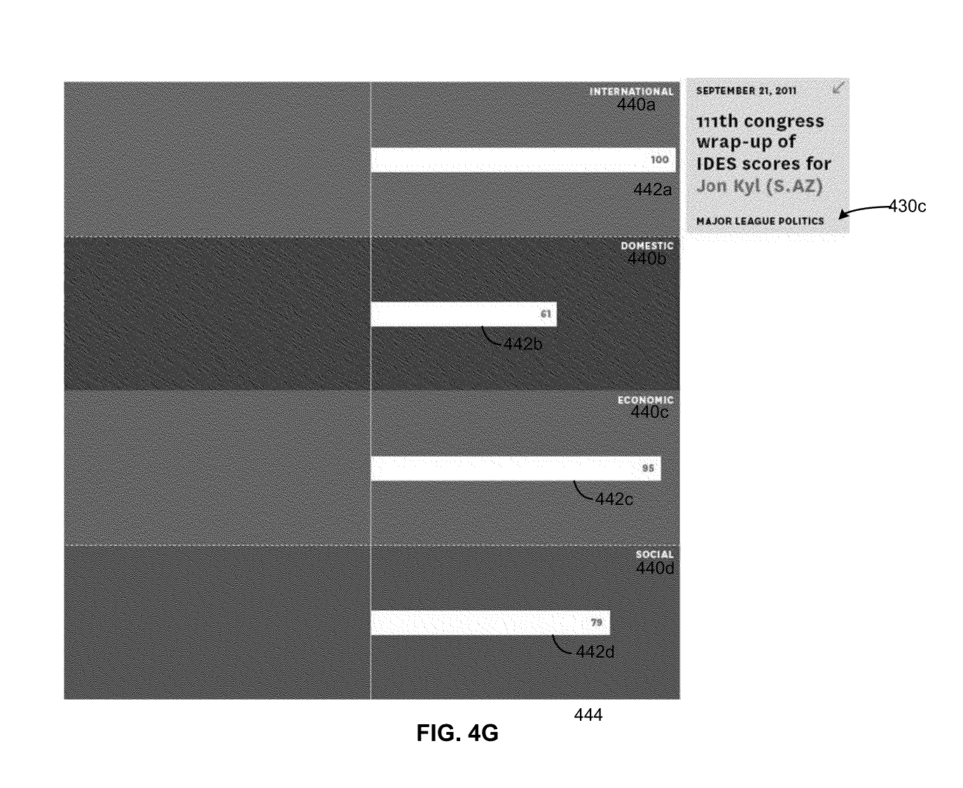

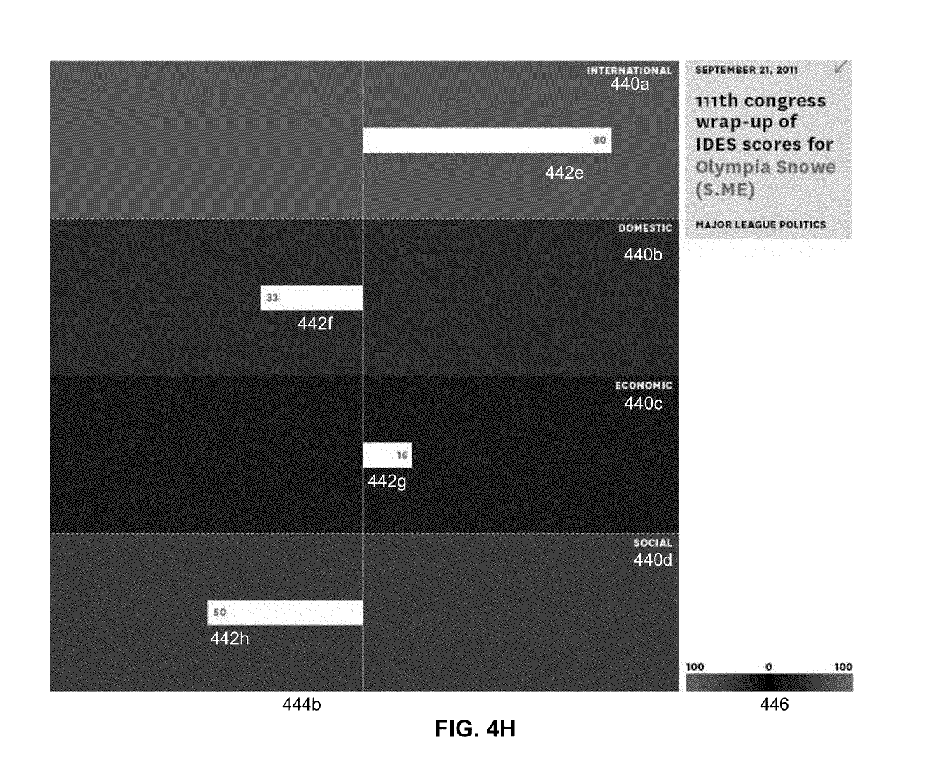

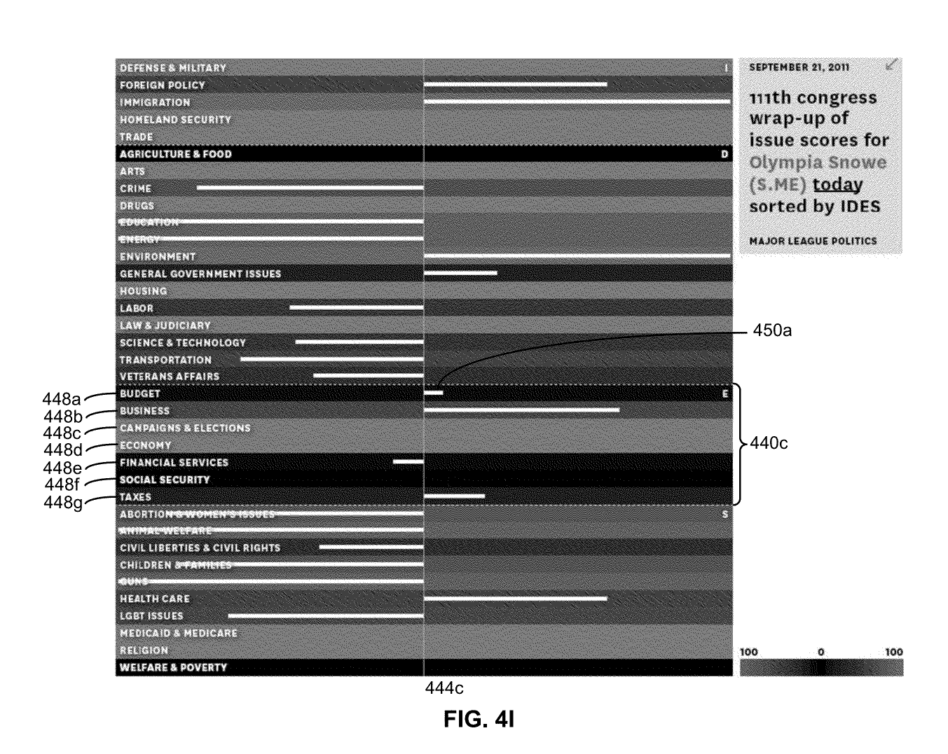

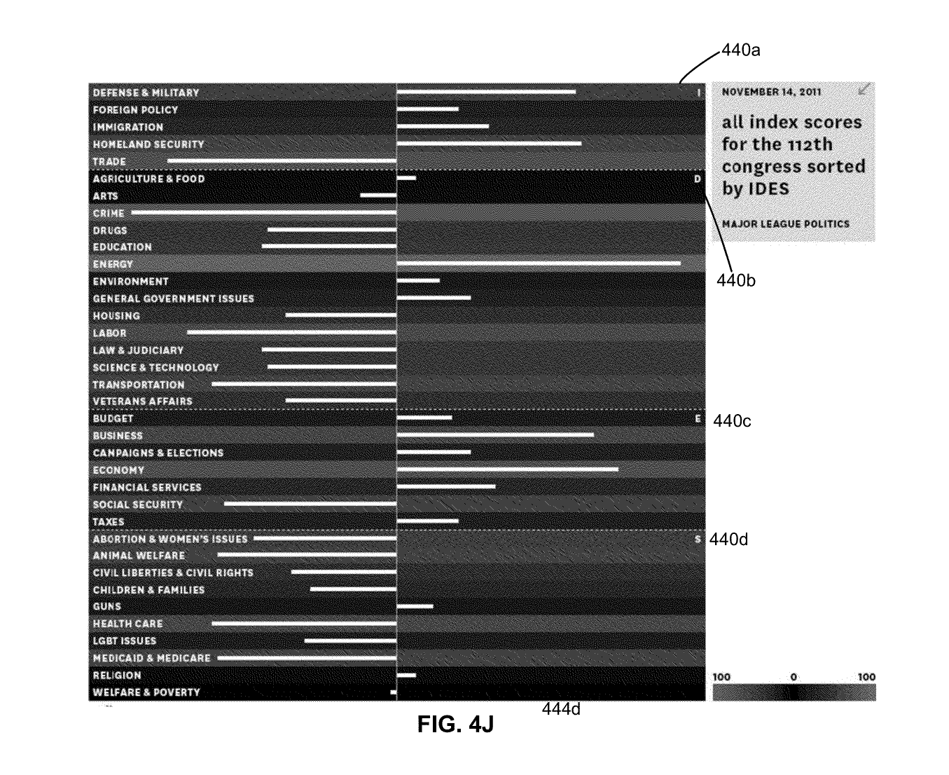

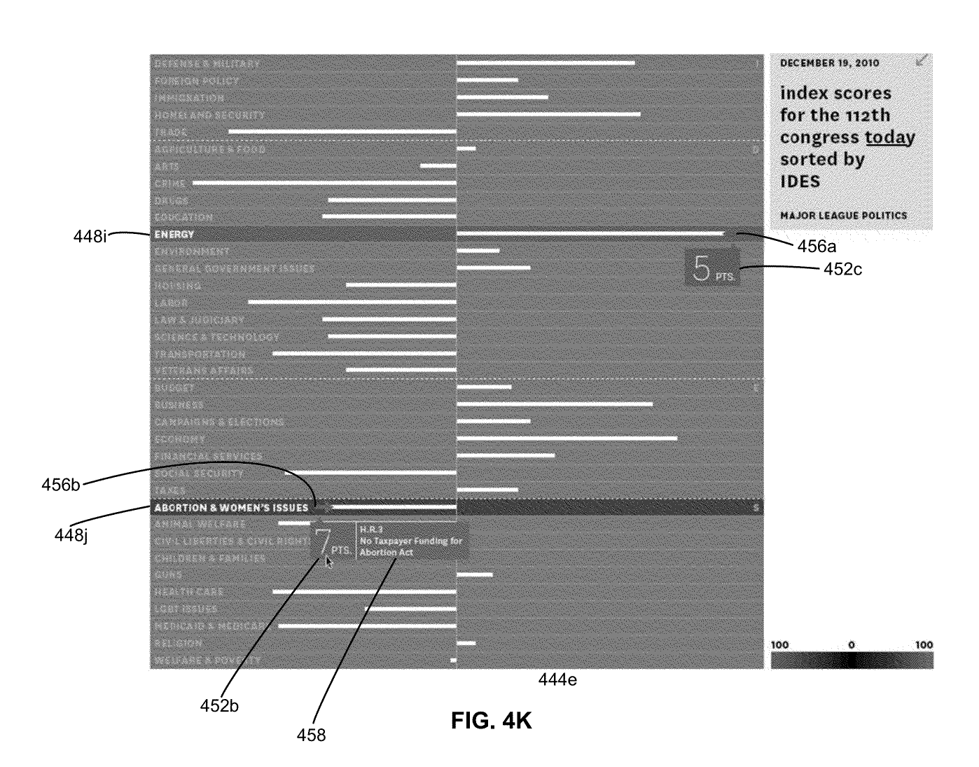

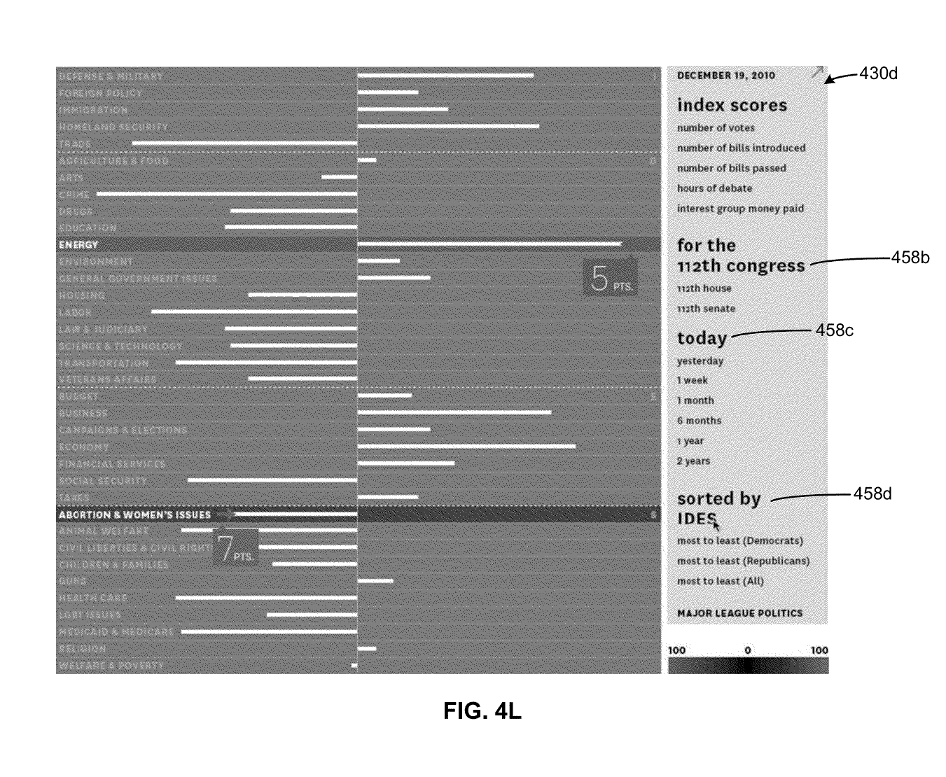

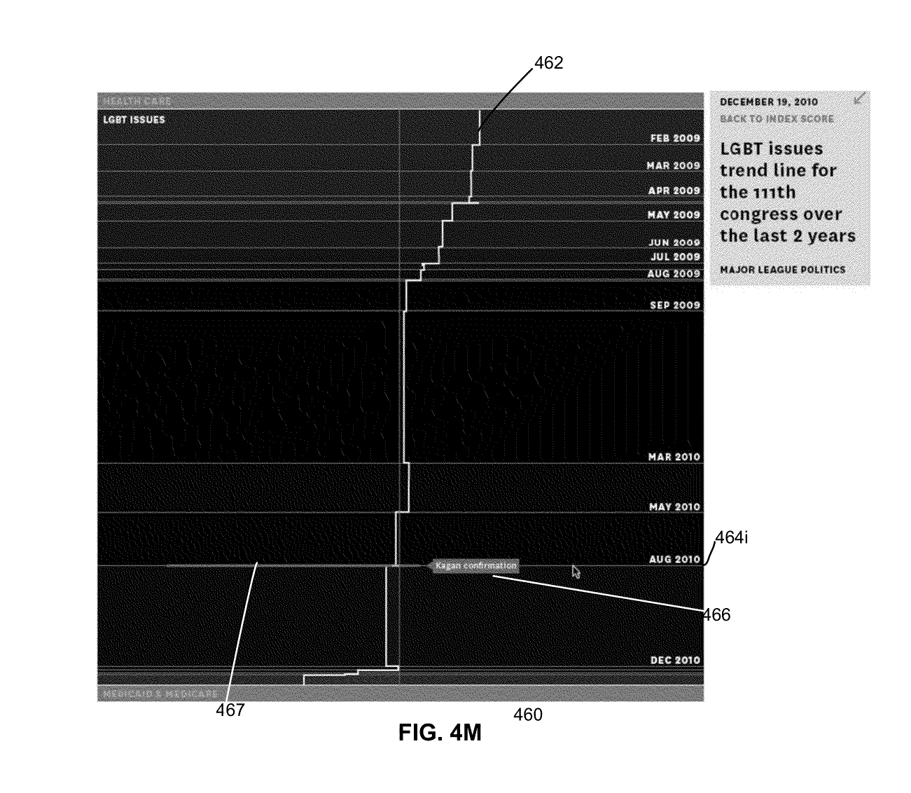

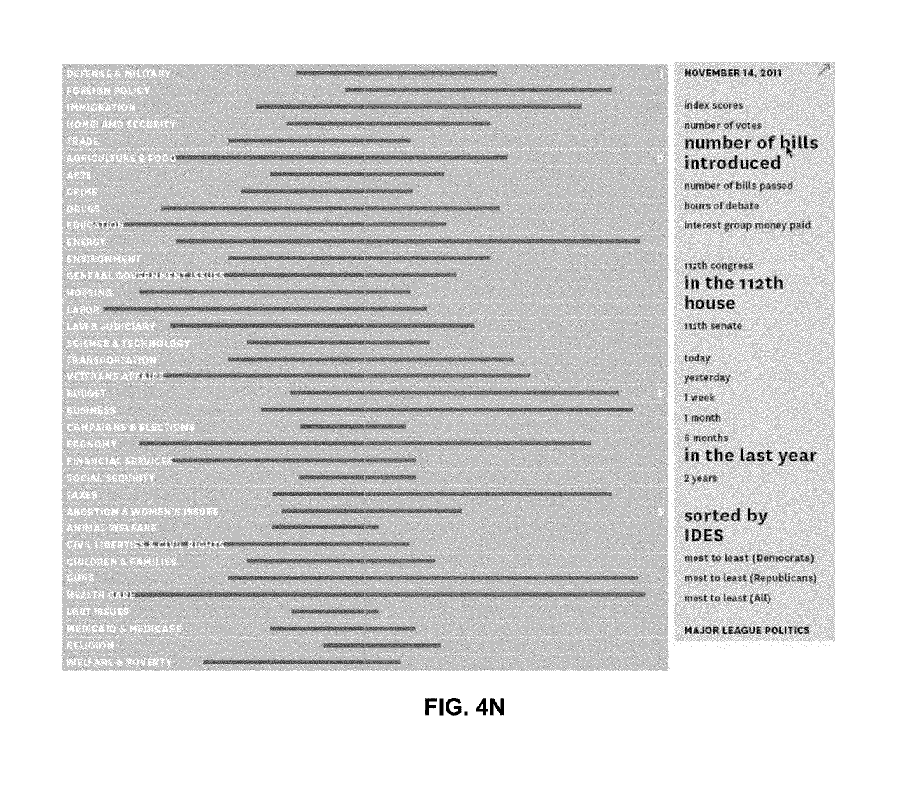

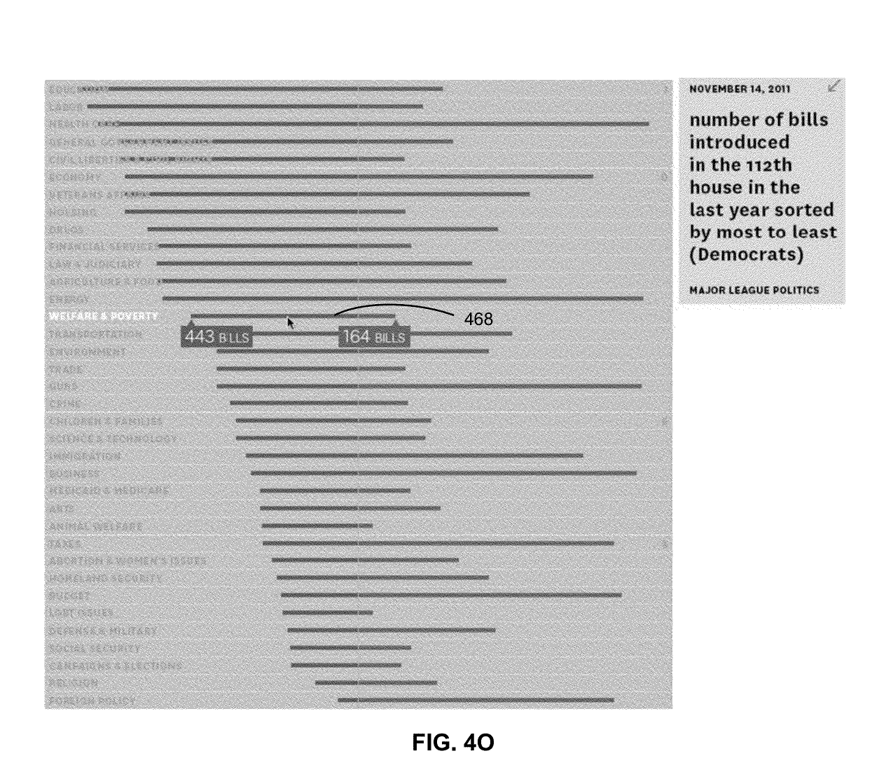

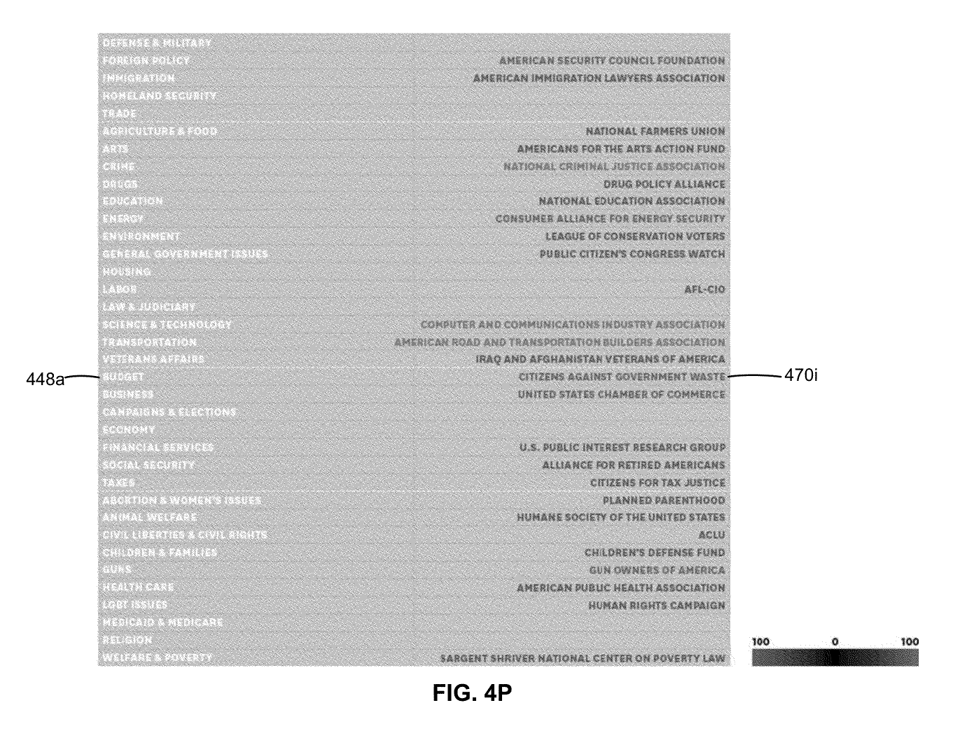

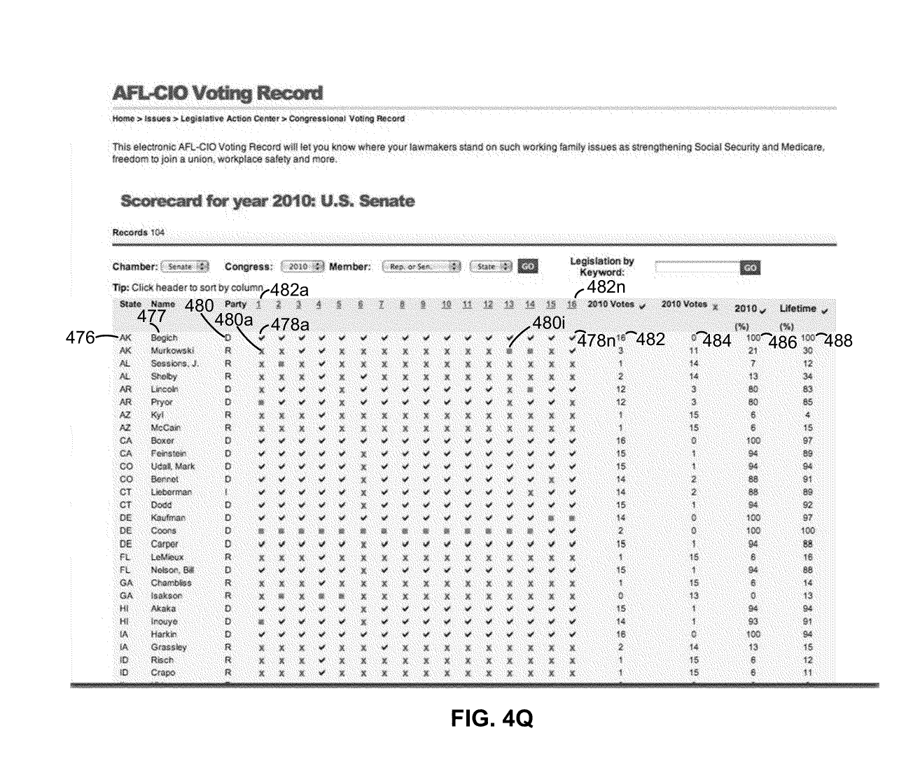

The data visualization engine 134 queries database 118 and generates graphical representations or visualizations to convey useful data about a political entity including the entity's member, chamber or branch, as well as about an issue or a political event. The data visualization engine 134 is configured to receive the parameters for a query from a user through a graphical query builder or another interface, query database 118 using the received parameters, receive the query results from the database 118 and generate the visualizations to represent the received results, and is one means for performing these functions. These generated visualizations are described below in context of FIGS. 4A-Q. In one embodiment, the database 118 stores information about a state's or (another level of government like city, county) chambers, members of the state's chambers, state's political events and issues, and the data visualization engine 134 generates visualizations conveying information about the state's actors, issues or political events.

The presentation layer 146 is configured to convert or conform the visualizations (generated by data visualization engine 134) across multiple platforms like mobile devices with varying sizes of display area, and is one means for performing this function.

Turning now to FIGS. 4A-Q, the various visualizations of the MLP system are described. FIG. 4A illustrates a news headline received by the live listener 106 from The Washington Times, a feed source, stating that “Republicans Block Repeal of Oil Tax Break.” In response to the news headline, a user of the MLP system creates a query using the visual query builder (an example of query builder is described in FIG. 4L below) provided by visualization engine 134 and requests information about the amount of money paid by oil and gas lobby to each senator who voted on the bill to repeal oil tax breaks. The visualization engine 134 receives the query, creates a visualization based on the received query, and transmits the visualization or a link to the visualization to the user's device. The user or the data processing system may provide this link with a description about the link to other users through an email, tweet or some other form of communication.

FIG. 4B illustrates a social media posting describing a link to the created visualization. In the embodiment illustrated in FIG. 4B, the description about the link corresponds to a natural language description of the query received by the visualization engine 134. For example, in FIG. 4B, the description states “oil & gas money paid to all senators sorted by votes on S.940 CLOSE BIG OIL TAX LOOPHOLES viewed as headshots #bigoil.” In this description, “senators” 406 string indicates that the request is for members who belong to the senate chamber, “oil & gas money paid” 402 string indicates that the requested members should only include members that received money from oil & gas interest groups, “S.940” 410 string indicates the identification number of the political event (a bill in this illustrated example) on which the requested members voted, “CLOSE BIG OIL TAX LOOPHOLES” 412 string indicates the name associated with the political event, “sorted by votes” 408 string indicates that the members that meet the criteria above be sorted based on their vote, and “viewed as headshots” 414 string indicates the requested view for the visualization. The underlying database query is readily formed using standard operators, e.g., SQL or the like.

In one embodiment, the social media posting illustrated in FIG. 4B includes an embedded link to the visualization. The link may be selected by selecting a part of the social media posting. Upon selection of the part, the generated visualization is displayed to the user by the presentation layer 146.

FIG. 4C illustrates an example visualization displaying pertinent details about members of a chamber who voted on a bill as requested in the query discussed above in FIG. 4B. The generated visualization includes headshots 416a-n, 428a-n and additional information for all senators that voted on the bill. In the visualization, as requested by the query, the displayed headshots 416a-n, 428a-n are sorted by the “yes” or “no” vote of each senator: headshots 416a-n belonging to senators that voted “no” and headshots 428a-n belonging to senators that voted “yes.”

Headshot 416i in an example headshot of a senator that voted “no,” and the headshot 416i displays a picture of the senator. Overlaid on the headshot is additional information about the senator and information related to the query that led to the illustrated visualization. For example, the overlaid information about the senator includes string 422a (“S.OK”) indicating that the headshot belongs to a senator from Oklahoma, string 424a (“James Inhofe, 76”) indicating the name and age of the senator, string 426a (“1987/2014”) indicating the first year the senator was elected and the year the senator is up for re-election. Additionally, overlaid strings 418,420 provide information requested in the query indicating the amount of money received by the senator from the oil & gas lobby and how the senator voted on bill S.940. Headshot 428a is a headshot of a senator that voted for the bill. The headshot 428a includes similar overlaid information as headshot 416i.

In one embodiment, the visualization also includes a query window 430a displaying the query that led to the visualization. The query window 420 may be moved, minimized or closed to view all the members in the visualization.

FIG. 4D illustrates an additional feature of the generated visualization displaying members of a chamber as requested by a query. In addition to headshots of senators who voted on the bill indicated in the query, the visualization may display a quote 432 or a comment of a member made during progression of the bill. This comment may be displayed on the visualization based on a criterion like displaying the quote 432 responsive to a user selecting or hovering a cursor over the headshot 416 of the senator that made the comment. The quote or comment is editorially selected from news sources or other media providers, and stored in the political events database 112, for example in the quotes from floor speeches 320 field.

FIG. 4E illustrates a second example of a visualization displaying information for members of a chamber based on the received query. The visualization includes a query window 430b including the query that led to the visualization. The included query requests a visualization with headshots view of number of bills sponsored by senators of 112^{th} Congress. Additionally, the query requests that the headshots be sorted by rate of sponsored bills passed by the senate. Headshot 434 is an example headshot included in the resulting visualization. Like the headshots in FIG. 4C, the headshot 434 includes overlaid strings 422b,424b,426b indicating that the headshot belongs to a senator, the state represented by the senator, the senator's name and age, the first year the senator was elected and the next year when the senator is up for re-election. Additionally, the headshot 434 includes overlaid strings 436, 438 indicating the number of bills (9) sponsored by the senator and the percentage (20%) of the sponsored bills that passed.

FIG. 4F illustrates a third example of a visualization displaying information about members of a chamber based on the received query. In this visualization, the members are represented by their homes instead of the headshot because the query requests that the member be viewed as homes. Different views (e.g., headshots, homes) gives the user of the data processing system the flexibility to display the members in a visualization in a manner that best conveys the information in relation to the bill included in the query. In FIG. 4F, the bill included in the query relates to mortgage assistance for homeowners and therefore displaying members' homes instead of their headshot gives the users pertinent information about the member's home-ownership status. For example, a picture of a lavish home may imply to a user that the member is living comfortably and may not necessarily understand the challenges of a homeowner struggling to make mortgage payments.

FIGS. 4G-Q illustrate various visualizations based on analysis of index scores for members of Congress, as generated by the MLP system. FIG. 4G illustrates a visualization displaying information about a member's voting record for a particular session based on the received query. The visualization includes a query box 430c to receive a query and a chart 444a to display the graphical representation of the query's results. In this illustration, the received query requests senator John Kyl's “IDES” score for 111^{th} Congress; the IDES score is a combined score for four issue categories, International, Domestic, Economic and Social. In response to receiving the query, the data processing system determines the scores based on the senator's index scores for political events related to the four issue categories that occurred during the 111^{th} Congress. The chart 444a is a horizontal, double bar ended bar chart with scores for the four categories represented on the X axis. The zero value of X axis in the double bar ended bar chart is at the horizontal center of the chart, and the bars extend to the left and the right. Scores that are oriented towards Republicans (or more generally conservatives) are shown as bars extending to the right. Scores that are oriented towards Democrats (or more generally liberals) are shown as bars extending to the left. The length of the bars is scaled to the scores, where the scores are normalized to a range of 0-100.

The chart 444a is vertically divided into four sections 440a-d including one section each for the four categories: section 440a for international category, section 440b for domestic category, section 440c for economic category and section 440d for social category. Each section 440a-d includes a bar 442a-d indicating the senator's score for the category. For example, bar 442a extends to the right of the zero value on X axis and indicates that the senator's orientation (e.g. based on senator's voting record) for the political events in international category that occurred during the 111^{th} Congress was conservative. The bar 442a also indicates a score 100 (the maximum score to the right) indicating the magnitude of the bar 442a. Other bars 442b-d indicate varying scores on the right for senator Jon Kyl's orientation on domestic, economic and social issues during the 111^{th} Congress, and have a length directly proportional to the corresponding score. For example, Sen. Kyl scores a 61 on domestic issues, the length of the bar is approximately 61% of the designated width of the field of the graphic used to the display the bar. In one embodiment, the horizontal sections 440a-d have a background color indicating whether the senator's orientation was conservative or liberal on related issues. As illustrated in FIG. 4G, the horizontal sections 440a-d have a red background indicating that the senator was conservative on all four issue categories represented in the chart 444a. The background colors for the horizontal sections are the base color determined by the merger 116 corresponding to the index scores associated with the horizontal sections.

FIG. 4H illustrates a second example of a visualization displaying information about a member's voting record for a particular session based on the received query. This visualization includes a chart 444b displaying IDES scores for another senator, Olympia Snowe, who votes conservative for some issues and liberal for others. Accordingly, bars 442e,g extending to right of the zero value on X axis indicate that senator Snowe votes conservatively on international and economic issues, and bars 442f,h extending to left of the zero value indicate that she votes liberally on domestic and social issues. Because the senator votes liberally on domestic and social issues, sections 440b, 440d have a blue background indicating that the senator voted liberally on the two issue categories represented in sections 440b, 440d.

Additionally, in one embodiment, the chart 444b displays different shades of background colors (red and blue) to represent different magnitudes of conservative and liberal voting record for a member. As indicated in the illustrated chart 444b, the background color for section 440d is darker blue than background color for section 440b (indicating that senator Snowe voted more liberally on social issues than domestic issues). Similarly, a lighter red background for section 440a and a darker red background for section 440c indicates that senator Snowe voted more conservatively on international issues than economic issues. A graph key 446 may be displayed with the chart 444b in the visualization to indicate how a varying shade of red or blue are meant to represent the degree of conservative or liberal orientation.

FIG. 4I illustrates a third example of a visualization displaying information about a member's voting record for a particular session based on the received query. The illustrated visualization includes a chart 444c displaying IDES scores for senator Olympia Snowe for various sub-categories within the four IDES categories (international, domestic, economic and social). In this visualization, the sections 440a-c are further divided into sub-sections representing various sub-categories within the categories corresponding to the sections 440a-c. For example, section 440c representing economic category has been divided into seven subsections 448a-g representing subcategories of economic category, namely budget, business, campaigns & elections, economy, financial services, social security and taxes. Like sections 440a-d in FIG. 4H, these subsections 448a-f have a bar and background color indicating the direction and magnitude of senator Olympia Snowe's orientation on the sub-categories. For example, bar 450a in subsection 448a extending slightly right of the zero value on X axis indicates that the senator tends to be slightly conservative on budgetary issues. Like bar 450a, the dark red background for subsection 448 also conveys the magnitude and direction of senator Snowe's orientation on budgetary issues. Subsections 448c,d,f do not have a bar indicating that either the senator's orientation is neutral for sub-categories associated with the subsections 448c,d,f or data for associated sub-categories was unavailable to determine the senator's orientation on the associated sub-categories. The background color grey for subsections 448c,d differentiates these subsections from subsection 448f, which has a black background. The grey background indicates that data for associated sub-categories was unavailable and the black background indicates the senator's neutral orientation for the sub-category associated with subsection 448f.

FIG. 4J illustrates a visualization displaying information about a Congress' voting record as a political entity, based on the received query. The visualization in this figure displays a chart 444d for 112^{th} Congress. Like the senator's chart 444c in FIG. 4I, the 112^{th} Congress' chart 444d includes sections 440a-d and subsections for various categories and sub-categories. Additionally, these sub-categories have background colors and bars indicating the directions and magnitudes of the 112^{th} Congress' orientation on various sub-categories. Charts similar to chart 444d can be generated for different chambers of a particular Congress indicating orientation on various issues or sub-categories.

FIG. 4K illustrates a visualization displaying a daily tracker chart indicating potential effects of a day's political events on the Congress' orientation. The daily tracker chart indicates potential effect on a chamber's or a member's orientation caused by a day's events. In other embodiments, charts may indicate potential effects on orientation caused by events occurring in a given time period (e.g., week, month, year). Like the chart 444d in FIG. 4J, chart 444e includes sections, subsections and corresponding bars indicating the directions and magnitudes of Congress' orientation on various issues. However, most subsections have a grey background indicating that sub-categories associated with these subsections are not being affected by political events of the day. Subsections 448i,j are the only subsections with background colors other than grey indicating that sub-categories associated with these subsections 448i,j may potentially be affected by the day's political events. Marker 452a indicates the magnitude and direction of the political events' potential effect on the 112^{th} Congress' orientation on energy sub-category. The text in marker 452a indicates that the Congress' orientation may move 5 points because of the current political events. The background color blue of marker 452 and arrow 456 pointing left indicates that the orientation may move in the liberal direction.

Similarly, marker 452b and arrow 456b indicate that the Congress's orientation may potentially move by 7 points in the conservative direction because of the day's political events. Additionally, field 458 accompanying marker 452b indicates the political event potentially affecting the orientation. In one embodiment, field 458 is displayed in response to selection of marker 452 or a cursor hovering over marker 452. In this illustration, field 458 indicates the identification and name of the bill (i.e. the political event) that may potentially affect the Congress's orientation. In one embodiment, field 458 may include a political headline about the political event instead of, or in addition to, the identification and name of the political event.

FIG. 4L illustrates a visualization displaying a query window used to build a query for requesting a chart. Query window 430d includes a chart type field 458a for selecting the criterion used to determine the magnitude and orientation of the bars for various subcategories (e.g. magnitude and orientation based on index scores, number of votes, number of bills introduced, number of bills passed, hours of debate and interest group money paid), chambers field 458b for specifying the chamber for which the visualization is created (e.g., 112^{th} Congress, 112^{th} senate, 112^{th} house), time period field 458c for which the chart is being created (e.g., yesterday, 1 week, 1 month, 6 month, 1 year, 2 years), and a sorting field 458d specifying the sorting criterion to determine the order in which the sub-categories should be displayed (e.g., sort subcategories based on the magnitude and orientation of the bar being most to least liberal, most to least conservative, or most to least in magnitude regardless of the orientation).

FIG. 4M illustrates a visualization including a trend line chart displaying a trend line indicating a change in a chamber's orientation on a particular issue over a period of time. In other embodiments, a user may select using the query box the entity (e.g. chamber, member, or the Congress) whose orientation change should be represented by the trend line 462. In one embodiment, the trend line chart 460 can be accessed by clicking a sub-category displayed in chart 444d illustrated in FIG. 4J.

As illustrated in the visualization, the trend line 462 indicates that the 111^{th} Congress gradually moved from conservative to liberal orientation between February, 2009 and December, 2010. Additionally, the trend line chart 460 includes white horizontal lines, like horizontal line 464i, representing a political event. The effect of the outcome of each political event on the trend line 462 is represented by the movement of the trend line 462 in the liberal or conservative direction when the trend line comes in contact with the horizontal line representing the political event.

Selecting or hovering a cursor over the horizontal line provides additional information about the political event associated with the trend line. For example, selection of horizontal line 464i leads to appearance of text box 466 describing the political event as confirmation of Justice Kagan. Additional information, like vote count overlay 467, can also be shown upon selection of the horizontal line 464i. The vote count overlay 467 shows the liberal and conservative affirmative vote counts, in corresponding blue and red line segments along the Political Event line, each segment of which is scaled in proportion to the corresponding vote counts.

FIG. 4N illustrates a visualization including a chart with bars for sub-categories indicating the number of bills introduced in a chamber. The bars in this chart extend in both liberal and conservative directions. The part of the bar on the left of zero value on X axis represents the number of liberal bills introduced in the chamber, and the part on the right represents the number of conservative bills. The introduced bills are determined to be conservative or liberal based on the orientation of the member that sponsored or co-sponsored the bill.

FIG. 4O illustrates the visualization of FIG. 4N with an additional layer of information displayed in response to selection of a bar. Here, the bars represent the number of bills introduced in each of the IDES subcategories by Democrats, sorted from most to least; this shows which political issues are of greatest importance to Democrats. The length of each bar is proportional to the number of bills introduced in the corresponding IDES subcategory. As illustrated, selection of a bar or hovering a cursor over a bar results in display of an overlay 468 indicating the number of liberal and conservative bills introduced in the chamber. As indicated in FIG. 4L, the magnitude and orientation of the bars can represent the normalized index score, number of votes, number of bills introduced, number of bills passed, hours of debate during a political event, and interest group money paid for an issue, and the bars can be ordered by any of these measures. Based on the value represented by the bar, an overlay may display information like the number of bills, amount of money paid by interest group or amount of hours of debate conducted for the events associated with the sub-category. Similarly, the query window can be used to indicate whether to sort the subcategories based on the magnitude and orientation of the sub-categories' bar from most to least liberal, most to least conservative, or most to least in magnitude regardless of the orientation.

FIG. 4P illustrates a visualization including a chart displaying sub-categories and their interest groups that provide scores for political events associated with the sub-categories. For example, the chart displays interest group 470i named Citizens Against Government Waste for the budget sub-category 448a. In one embodiment, the interest group's name 470i is displayed in a color indicating the orientation of the interest group (e.g., name displayed in blue for liberal groups and in red for conservative groups). The orientation of the interest group may be determined based on how the interest group scores democrat or liberal members of a chamber versus the republicans or conservative members.

FIG. 4Q illustrates a scorecard generated by the data processing system indicating the senators' voting scores for year 2010 on political events associated with labor issue sub-category as determined by an interest group. The scorecard includes for each senator, the senator's state 476, name 477, party 480, votes 478a-n on the sixteen political events in 2010 associated with labor, total number of supporting votes 482 for the labor-related political events, total number of opposing votes 484, percentage of supporting votes 486 during 2010 and percentage of supporting votes throughout the senator's life. A senator's supporting, opposing and abstinence from vote may be represented by different graphical icons. For example, as illustrated in FIG. 4Q, a senator's supporting vote is indicated by a checkmark as indicated for vote 478a, opposing vote is indicated by a cross as indicated for vote 480a, and abstinence from vote is represented by a square as indicated by vote 480i. Additionally, the labor-related political events that senators voted on are represented by selectable serial numbers 482a-n. Selection of any of these serial numbers 482a-n displays additional information about the corresponding political event.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for transmitting a visualization indicating a political entity's orientation on an issue, the method comprising:
receiving a score indicating the political entity's orientation on the issue, the score including an indicator on whether the entity's orientation is conservative or liberal;
storing the received score;
receiving a request for the political entity's orientation on the issue;
generating a visualization based on the received score, the visualization indicating the political entity's orientation on the issue; and
transmitting the created visualization.

2. The computer-implemented method of claim 1, wherein:
the generated visualization includes a double ended bar chart, the double ended bar chart including an X axis and a bar, the X axis comprising a zero value, a region left to the zero value representing at least one of conservative or liberal orientation, and a region right to the zero value representing at least one of conservative or liberal orientation, the bar representing the entity's political orientation, wherein the bar extends to the region left of the zero value or the region right of the zero value based on the indicator included in the score.

3. The computer-implemented method of claim 2, wherein the score includes a magnitude indicating extent of liberal or conservative orientation of the political entity on the issue, and a length of the bar extending to the right or left of the zero is based on the magnitude.

4. The computer-implemented method of claim 2, wherein the region of the X axis including the bar comprises a background color or the bar comprises a color, the color or the background color indicating the entity's political orientation.

5. The computer-implemented method of claim 4, wherein the color or the background color has a plurality of shades, each shade representing the extent of liberal or conservative orientation of the political entity, and the color of the bar or the background color of the region of the X axis is a shade from the plurality of shades selected based on the magnitude of the score.

6. The computer-implemented method of claim 2, wherein the issue is one of a plurality of issues in a category, and the double ended bar chart includes a bar and a region to the left of the X axis and a region to the right of X axis for each of the plurality of issues.

7. The computer-implemented method of claim 2, wherein the visualization further comprises a marker corresponding to the bar, the marker indicating a potential change in the political entity's orientation on the issue based on occurrence of a political event within a time period.

8. The computer-implemented method of claim 7, wherein a color associated with the marker indicates whether the potential change in the entity's orientation would be liberal or conservative.

9. The computer-implemented method of claim 7, wherein a field accompanying the marker provides information about the political event whose occurrence would cause the potential change.

10. The computer-implemented method of claim 1, wherein
the visualization comprises a trend line chart including a trend line for the issue, the trend line chart including an X axis, the X axis comprising a zero value, a region left to the zero value representing at least one of conservative or liberal orientation, and a region right to the zero value representing at least one of conservative or liberal orientation, the trend line chart further including a plurality of horizontal lines representing political events, the trend line on the chart indicating a trend of the political entity's orientation on the issue through a time period, the trend line positioned to left or right of its previous position upon or after coming in contact with one of the plurality of horizontal lines, the positioning to left or right of the trend line based on whether the one of the plurality of horizontal lines represents a political event that indicated a change in the political entity's orientation on the issue towards a liberal or conservative direction.

11. The computer-implemented method of claim 10, wherein selection of or a cursor hovering over the one of the plurality of horizontal lines results in displaying information about the political event associated with the one of the plurality of trend lines.

12. A computer program product for transmitting a visualization indicating a political entity's orientation on an issue, the computer program product comprising a computer-readable storage medium containing computer program code for:
receiving a score indicating the political entity's orientation on the issue, the score including an indicator on whether the entity's orientation is conservative or liberal;
storing the received score;
receiving a request for the political entity's orientation on the issue;
generating a visualization based on the received score, the visualization indicating the political entity's orientation on the issue; and
transmitting the created visualization.

13. The computer program product of claim 12, wherein:
the generated visualization includes a double ended bar chart, the double ended bar chart including an X axis and a bar, the X axis comprising a zero value, a region left to the zero value representing at least one of conservative or liberal orientation, and a region right to the zero value representing at least one of conservative or liberal orientation, the bar representing the entity's political orientation, wherein the bar extends to the region left of the zero value or the region right of the zero value based on the indicator included in the score.

14. The computer program product of claim 13, wherein the score includes a magnitude indicating extent of liberal or conservative orientation of the political entity on the issue, and a length of the bar extending to the right or left of the zero is based on the magnitude.

15. The computer program product of claim 13, wherein the region of the X axis including the bar comprises a background color or the bar comprises a color, the color or the background color indicating the entity's political orientation.

16. The computer program product of claim 15, wherein the color or the background color has a plurality of shades, each shade representing the extent of liberal or conservative orientation of the political entity, and the color of the bar or the background color of the region of the X axis is a shade from the plurality of shades selected based on the magnitude of the score.

17. The computer program product of claim 13, wherein the issue is one of a plurality of issues in a category, and the double ended bar chart includes a bar and a region to the left of the X axis and a region to the right of X axis for each of the plurality of issues.

18. The computer program product of claim 13, wherein the visualization further comprises a marker corresponding to the bar, the marker indicating a potential change in the political entity's orientation on the issue based on occurrence of a political event within a time period.

19. The computer program product of claim 18, wherein a color associated with the marker indicates whether the potential change in the entity's orientation would be liberal or conservative.

20. The computer program product of claim 18, wherein a field accompanying the marker provides information about the political event whose occurrence would cause the potential change.

21. The computer program product of claim 13, wherein:
the visualization comprises a trend line chart including a trend line for the issue, the trend line chart including an X axis, the X axis comprising a zero value, a region left to the zero value representing at least one of conservative or liberal orientation, and a region right to the zero value representing at least one of conservative or liberal orientation, the trend line chart further including a plurality of horizontal lines representing political events, the trend line on the chart indicating a trend of the political entity's orientation on the issue through a time period, the trend line positioned to left or right of its previous position upon or after coming in contact with one of the plurality of horizontal lines, the positioning to left or right of the trend line based on whether the one of the plurality of horizontal lines represents a political event that indicated a change in the political entity's orientation on the issue towards a liberal or conservative direction.

22. The computer program product of claim 21, wherein selection of or a cursor hovering over the one of the plurality of horizontal lines results in displaying information about the political event associated with the one of the plurality of trend lines.
